(19) United States
(12) Patent Application Publication
(10) Pub. No.: US 2021/0395983 A1
(43) Pub. Date: Dec. 23, 2021

(54) WATER SUPPLY CONTROL DEVICE

(71) Applicant: TING SHAN ENTERPRISE CO., LTD., Taichung City (TW)

(72) Inventors: Hsueh-Hsin HWANG, Taichung City (TW); Hsin-Feng CHIEN, Kaohsiung City (TW)

(21) Appl. No.: 17/246,069

(22) Filed: Apr. 30, 2021

(30) Foreign Application Priority Data
Jun. 17, 2020 (TW) 109120419

(51) Int. Cl. E03C 1/05; F16K 31/62

(52) U.S. Cl. CPC E03C 1/052; F16K 31/62

(57) ABSTRACT

A water supply control device includes a valve casing, a piston, an actuator and a resilient member. The valve casing has an inside space defining a passage hole connected between valve inlet and outlet thereof. The piston includes an actuated portion partially exposed from the inside space to be actuated by the actuator, a valve plug portion opposite to the actuated portion and disposed movably in the passage hole to be urged by the resilient member, and a diaphragm member disposed between the actuated portion and the valve plug portion and extending across the inside space. The diaphragm member prevents water from flowing to the actuated portion of the piston from the passage hole.

### CROSS-REFERENCE TO RELATED APPLICATION

This application claims priority to Taiwanese Patent Application No. 109120419, filed on Jun. 17, 2020.

### FIELD

The disclosure relates to a water supply control device, and more particularly to a press-type water supply control device.

### BACKGROUND

FIGS. 1 and 2 illustrate a conventional water supply control device to control a spout 11 on a washbasin 1. The conventional water supply control device includes an inlet pipe 21, an outlet pipe 22 connected to the spout 11, a valve unit 23 connecting the inlet pipe 21 and the outlet pipe 22. The valve unit 23 includes a casing 24 having an inside space 240, a piston 25 movably extending in the inside space 240, a lever type actuator 26 pivotally connected to the casing 24 to abut the piston 25, and a resilient member 27 disposed in the inside space 240 to urge the piston 25 to abut the actuator 26.

The casing 24 further has a valve inlet 241 and a valve outlet 242.

The piston 25 has an actuated portion 251 exposed from the inside space 240 to abut the actuator 26, and a valve plug portion 252 conically enlarged from the actuated portion 251 to abut the resilient member 27. The valve plug portion 252 can prevent fluid communication between the valve inlet 241 and the valve outlet 242.

To dispense water from the spout 11, the actuator 26 is pushed by a user's knee to press the actuated portion 251; the valve plug portion 252 is moved by the actuated portion 251 toward the resilient member to open fluid communication between the valve inlet 241 and the valve outlet 242. Accordingly, the water is supplied through the inlet pipe 21, the valve inlet 241, the valve outlet 242, the outlet pipe 22 and the spout 11.

To stop dispensing water, the actuator 26 is released from the user's knee to stop pressing the piston 25. The resilient member 27 urges the valve plug portion 252 to move in a direction toward the actuated portion 251. The valve plug portion 252 closes fluid communication between the valve inlet 241 and outlet 242 and prevents the water from flowing to the valve outlet 242 to stop supplying the water to the spout 11.

However, after a period of time of use, hard water residue is built up between the piston 25 and the inner surface of the casing 24 and adversely affects smooth operation of the piston 25. Because the hard water residue may even cause the piston 25 to get stuck in the casing 24, there is a room for improvement in the conventional water supply control device.

### SUMMARY

Therefore, an object of the disclosure is to provide a water supply control device that can alleviate the drawback of the prior art.

According to the disclosure, a water supply control device includes a valve unit that includes a valve casing, a piston, an actuator, and a resilient member.

The valve casing has a valve inlet, a valve outlet, and an inside space connected to the valve inlet and outlet. A portion of the inside space defines a passage hole for passage of water from the valve inlet to the valve outlet.

The piston movably extends in the inside space. The piston includes an actuated portion partially exposed from the inside space, a valve plug portion opposite to the actuated portion and disposed in the passage hole, and a diaphragm member disposed between the actuated portion and the valve plug portion and extending across the inside space. The diaphragm member prevents water from flowing to the actuated portion of the piston from the passage hole.

The actuator is to actuate the actuated portion of the piston.

The resilient member is disposed in the inside space and urges the valve plug portion to block the passage hole so that the piston is in a blocking position.

The piston is moved by the actuator to a non-blocking position, where the valve plug portion unblocks the passage hole.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a conventional water supply control device connected to a washbasin;

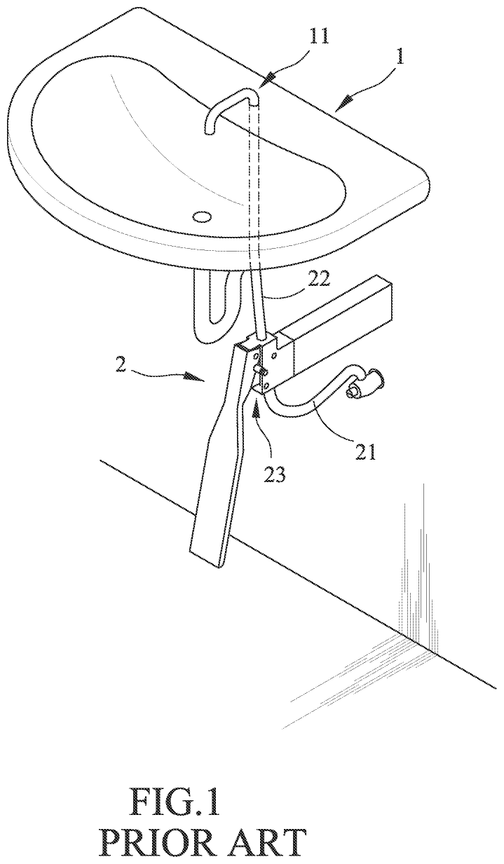

FIG. 2 is a sectional view illustrating a valve unit of the conventional water supply control device;

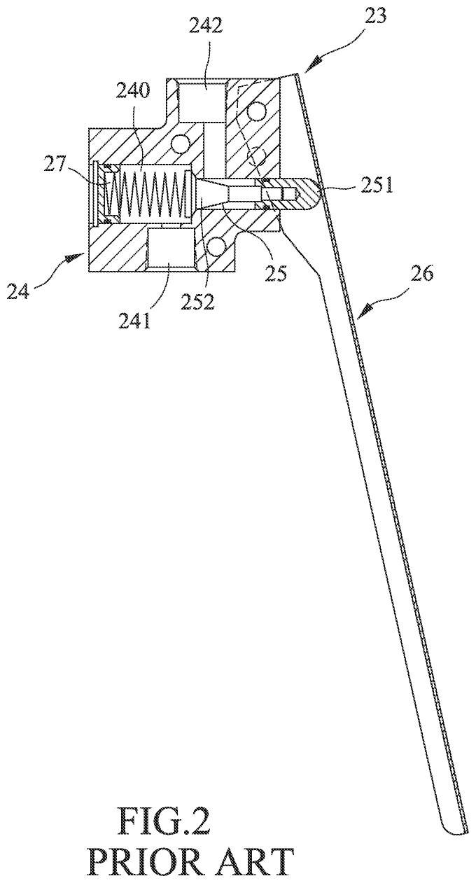

FIG. 3 is a perspective view illustrating a water supply control device according to a first embodiment of the disclosure connected to a washbasin;

FIG. 4 is a perspective view of the first embodiment illustrating a valve unit of the water supply control device;

FIG. 5 is a sectional view of the first embodiment illustrating a piston of the valve unit in a blocking position;

FIG. 6 is a fragmentary sectional view of the first embodiment illustrating the valve unit having a locking member inserted into a lock hole;

FIG. 7 is a view similar to that of FIG. 5, but illustrating the piston in a non-blocking position;

FIG. 8 is a fragmentary sectional view similar to that of FIG. 6, but illustrating the locking member released from the lock hole;

FIG. 9 is a perspective view illustrating a water supply control device according to a second embodiment of the disclosure connected to a washbasin;

FIG. 10 is a perspective view of illustrating a valve unit of the second embodiment;

FIG. 11 is a partly sectional view of the second embodiment illustrating an extension lever of an actuator and a mounting rod;

FIG. 12 is a fragmentary sectional view illustrating the actuator of the second embodiment;

FIG. 13 is a perspective view illustrating a water supply control device according to a third embodiment of the disclosure connected to a wash basin;

FIG. 14 is a perspective view illustrating a valve unit of the third embodiment.

FIG. 15 is a sectional view illustrating the valve unit of the third embodiment;

FIG. 16 is a perspective view illustrating a water supply control device according to a fourth embodiment of the disclosure; and

FIG. 17 is a fragmentary sectional view illustrating a valve unit of the fourth embodiment.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

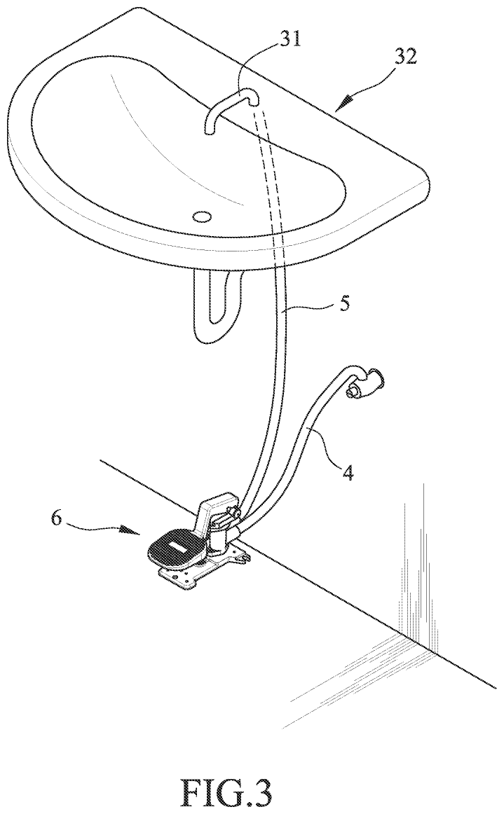

FIG. 3 illustrates a water supply control device according to a first embodiment of the disclosure connected to a washbasin 32. The water supply control device includes a water dispenser 31 mounted on the washbasin 32, an outlet pipe 5 connected to the water dispenser 31, an inlet pipe 4 connected to a water source, and a valve unit 6 connected between the inlet pipe 4 and the outlet pipe 5.

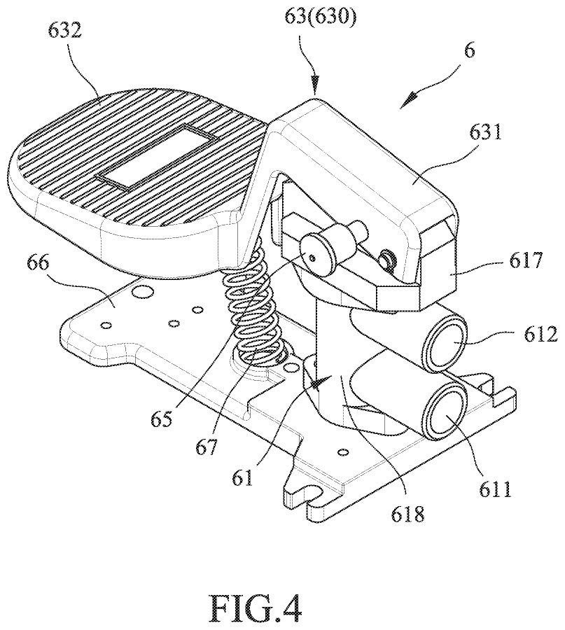

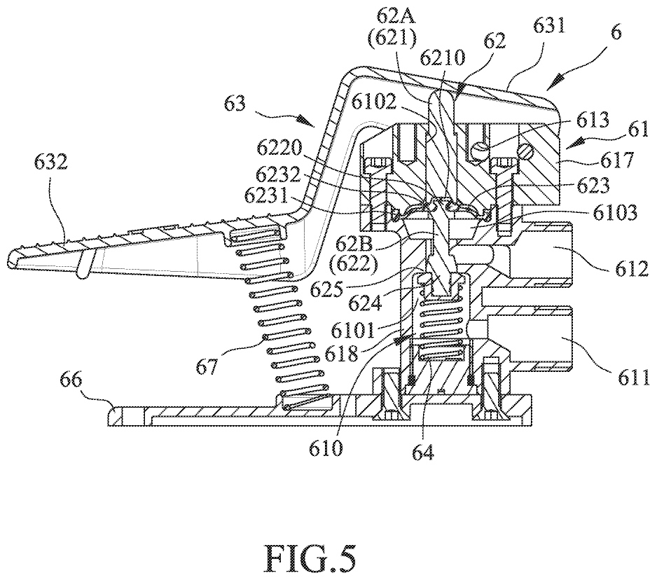

Referring to FIGS. 4 and 5, the valve unit 6 includes a valve casing 61, a piston 62, an actuator 63, a resilient member 64, a locking member 65, a mounting board 66 and a biasing member 67.

The valve casing 61 has a first casing part 617 and a second casing part 618 secured to each other. The first and second casing parts 617, 618 cooperate with each other to form an inside space 610. The second casing part 618 has a valve inlet 611 connected to the inlet pipe 4 and a valve outlet 612 connected to the outlet pipe 5. The inside space 610 is connected to the vale inlet 611 and the valve outlet 612. A portion of the inside space 610 near the valve inlet 611 and outlet 612 defines a passage hole 6101 for passage of water from the valve inlet 611 to the valve outlet 612.

The resilient member 64 is a compression spring disposed in the inside space 610 and made of an anti-corrosion material.

The piston 62 movably extends in the inside space 610. The piston 62 includes an actuated portion 621 partially exposed from the inside space 610, a valve plug portion 622 opposite to the actuated portion 621 and disposed in the passage hole 6101, and a diaphragm member 623 disposed between the actuated portion 621 and the valve plug portion 622 and extending across the inside space 610. The diaphragm member 623 is formed as a bonnet shape and is made of a rubber material. The diaphragm member 623 prevents water from flowing to the actuated portion 621 of the piston 62 from the passage hole 6101. The valve plug portion 622 of the piston 62 has a conical portion 624 gradually enlarged in a direction toward the resilient member 64. The resilient member 64 abuts with an end of the valve plug portion 622 and urges the conical portion 624 to block the passage hole 6101 so that the piston 62 is in a blocking position.

In this embodiment, as shown in FIG. 5, the inside space 610 of the valve casing 61 further defines a piston slide hole 6102 and a working chamber 6103. The piston slide hole 6102 is disposed in the first casing part 617 and receives the actuated portion 621 of the piston 62. The working chamber 6103 is connected between the piston slide hole 6102 and the passage hole 6101.

The piston 62 is divided into first and second piston sections 62A, 62B. The first piston section 62A has the actuated portion 621 and an engagement groove 6210. The second piston section 62B has the valve plug portion 622 and an engagement protrusion 6220. The engagement protrusion 6220 has a nipple-shaped protrusion formed with a constricted neck and a flange adjacent to the constricted neck.

The diaphragm member 623 extends across the working chamber 6103 and is movable between a junction of the piston slide hole 6102 and the working chamber 6103 and a junction of the passage hole 6101 and the working chamber 6103. The diaphragm member 623 has a peripheral edge portion 6231 fixed to the valve casing 61, and an intermediate part 6232 surrounded by the peripheral edge portion 6231. The peripheral edge portion 6231 is clamped between the first and second casing parts 617, 618. The intermediate part 6232 of the diaphragm member 623 is clamped between the engagement groove 6210 and the engagement protrusion 6220. A middle of the intermediate part 6232 of the diaphragm member 623 has a shape complementary to the nipple-shaped protrusion of the engagement protrusion 6220.

The actuator 63 includes a main lever 630 that has a pivoted portion 631 and a trigger portion 632. The pivoted portion 631 is pivotally connected to the first casing part 617. The trigger portion 632 is opposite to the pivoted portion 631. In this embodiment, the trigger portion 632 has a foot step plate. The actuated portion 621 of the piston 62 has a protruding end exposed from the inside space 610 and abutting the main lever 630 between the pivoted portion 631 and the trigger portion 632.

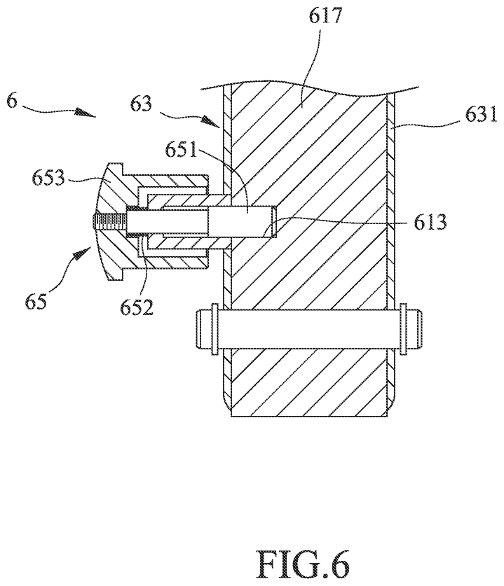

As shown in FIGS. 5 and 6, the first casing part 617 of the valve casing 61 has a lock hole 613 proximate to the pivoted portion 631 of the actuator 63. The locking member 65 is disposed on the pivoted portion 631 and extendable into the lock hole 613. The locking member 65 has a locking pin 651 and a spring 652 sleeved on the locking pin 651. The locking pin 651 extends movably into the lock hole 613 through the pivoted portion 631 of the actuator 63.

Referring back to FIGS. 3 to 5, the mounting board 66 supports the valve casing 61 opposite to the actuator 63 and is positioned to a floor to prevent the valve casing 61 from moving with respect to the floor when the foot step plate of the trigger portion 632 is pressed.

The biasing member 67 is connected between the foot step plate of the trigger portion 632 and the mounting board 66. The biasing member 67 urges the trigger portion 632 to move away from the mounting board 66.

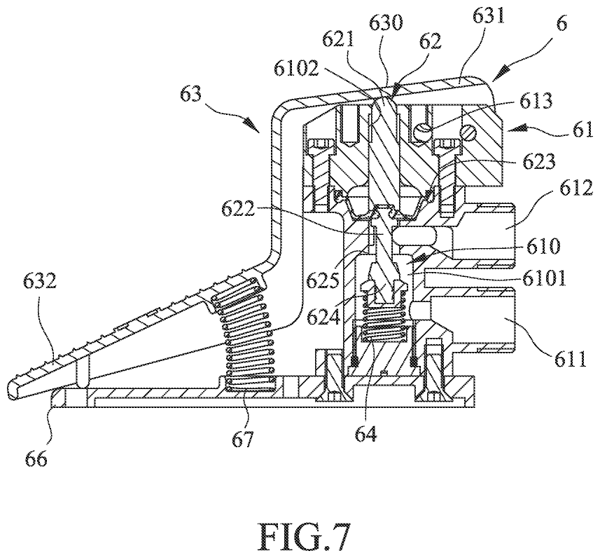

Referring to FIG. 7 in combination with FIG. 5, the piston 62 is movable by the actuator 63 and the resilient member 64 between a non-blocking position (See FIG. 7) and the blocking position (See FIG. 5).

As shown in FIG. 7, when the foot step plate of the trigger portion 632 is pressed by the user's foot to operate the main lever 630 of the actuator 63, the main lever 630 pushes the actuated portion 621 of the piston 62 to move the piston 62 to the non-blocking position, the valve plug portion 622 unblocks the passage hole 6101 and the resilient member 64 is compressed to produce a resilient force. Because the passage hole 6101 is unblocked, water from the outlet pipe 4 flows to the water dispenser 31 through the valve inlet 611, the passage hole 6101, the valve outlet 612 and the outlet pipe 5. At the same time, the diaphragm member 623 is moved by the piston 62 to the junction of the passage hole 6101 and the working chamber 6103; the water is prevented by the diaphragm member 623 from flowing into the piston side hole 6102.

As shown in FIG. 5, when the actuated portion 621 of the piston 62 is deactivated by releasing the trigger portion 632 of the main lever 630 of the actuator 63, the resilient force of the resilient member 64 urges the valve plug portion 622 of the piston 62 to restore the piston 62 to the blocking position. Because the valve plug portion 622 of the piston 62 is urged by the resilient member 64, the conical portion 624 blocks the passage hole 6101 to prevent the water from flowing to the valve outlet 612, and the diaphragm member 623 is moved by the piston 62 to the junction of the piston slide hole 6102 and the working chamber 6103 to prevent the water from flowing to the piston slide hole 6102.

During the movement of the piston 62 to the non-blocking or blocking positions, the diaphragm member 623 effectively prevents the water from flowing to the actuated portion 621 of the piston 62 and thereby reduces the risk of hard water scale build-up in the piston slide hole 6102.

In this embodiment, the water amount delivered from the valve outlet 612 is controllable by adjusting the degree of opening the passage hole 6101 through movement of the conical portion 624 of the piston 62 relative to a valve seat 625 defined by an inner surface of the valve casing 61 within the passage hole 6101. In particular, because the conical portion 624 and the valve seat 625 have conical surfaces, the gap between the conical portion 624 and the valve seat 625 gradually becomes large while the piston 62 is moving toward the non-blocking position. The water amount at the valve outlet 612 is maximum when the passage hole 6101 is fully opened (see FIG. 7).

The water supply control device of the disclosure is hands-free and is convenient to be activated. A user can use his/her foot to press the trigger portion 632 of the actuator 63 to dispense water from the water dispenser 31 for washing hands. Therefore, the water dispenser 31 can dispense water without being directly touched by the user's hands, and an antibacterial effect can be achieved to prevent the user's hand from contamination. Because water can stop flowing out from the water dispenser 31 as soon as the user's foot leaves the trigger portion 632, the problem of forgetting to turn off the water supply control device of the disclosure will not occur, and water will not be wasted.

Referring to FIGS. 6, 7 and 8, when the user presses the trigger portion 632 of the actuator 63 through his/her foot to actuate the piston 62 to the non-blocking position (see FIG. 7), the locking member 65 is aligned with the lock hole 613. Subsequently, the user may press a knob 653 of the locking member 65 to move the locking pin 651 into the lock hole 613. At this state, even though the user releases the trigger portion 632 of the actuator 63 from his/her foot, the trigger portion 632 and the actuator 63 do not move so that the piston 62 is continuously kept in the non-blocking position. This is because the resilient member 64 urges the piston 62 to move toward the actuator 63 and the actuator 63 pushes the locking pin 651 to be in tight contact with the upper part of the boundary surface of the lock hole 613. A frictional force is therefore generated between the locking pin 651 and the lock hole 613 against a biasing force of the spring 652. As such, the locking pin 651 is fixedly positioned in the lock hole 613; thus, the actuator 63 is held in position and the piston 62 is immobilized in the dispensing water through the water dispenser 31.

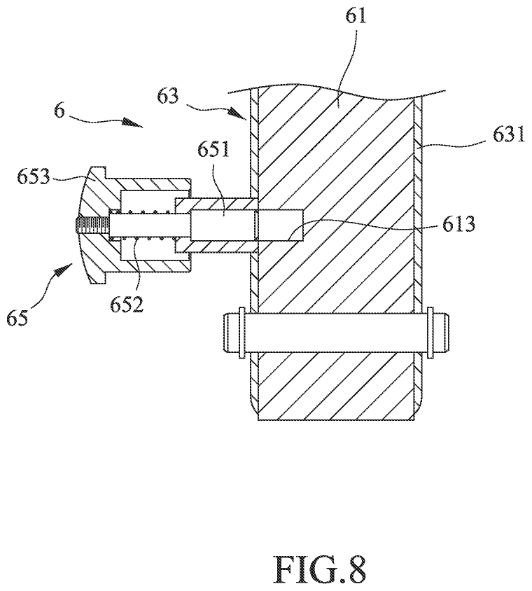

As shown in FIG. 8 in combination with FIG. 5, to stop continuously dispensing water, the actuator 63 may be slightly pressed against the biasing member 67 through the user's foot. As this state, the locking pin 651 is slightly moved downward so that the frictional force between the locking pin 651 and the lock hole 613 disappears. In absence of the frictional force on the locking pin 651, the biasing force of the spring 652 is able to move the locking pin 651 out of the lock hole 613, so that the actuator 63 is not restricted and stops pressing the piston 62. The piston 62 is urged by the resilient member 64 to move to the blocking position.

Notably, when the trigger portion 632 of the actuator 63 is pressed by the user's foot to move to the mounting board 66, the biasing member 67 is compressed. When the actuator 63 is released, the biasing member 67 urges the trigger portion 632 to move away from the mounting board 66 until the piston 62 moves to the non-blocking position. Through the cooperation of the biasing member 67 with the resilient member 64, the returning action of the actuator 63 is efficient. Thus, the actuator 63 can be made from a variety of materials, even from a heavy material. In this embodiment, the trigger portion 632 of the actuator 63 has a heavy weight. However, despite the heavy weight of the actuator 63, the high strength biasing member 67 is able to return the actuator 63. In addition, due to the biasing member 67 which shares the task of urging the actuator 63 with the resilient member 64, the risk of causing fatigue to the resilient member 64 can be reduced.

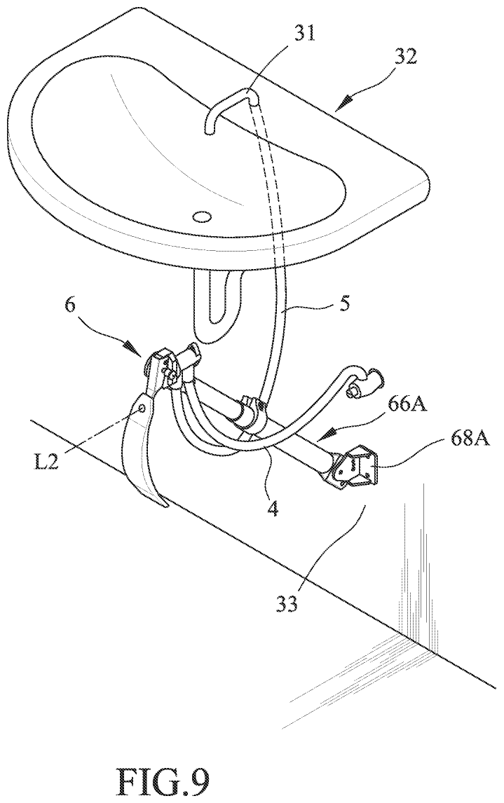

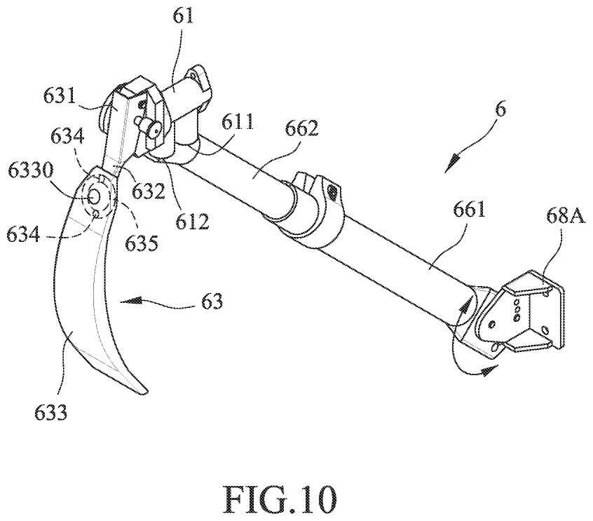

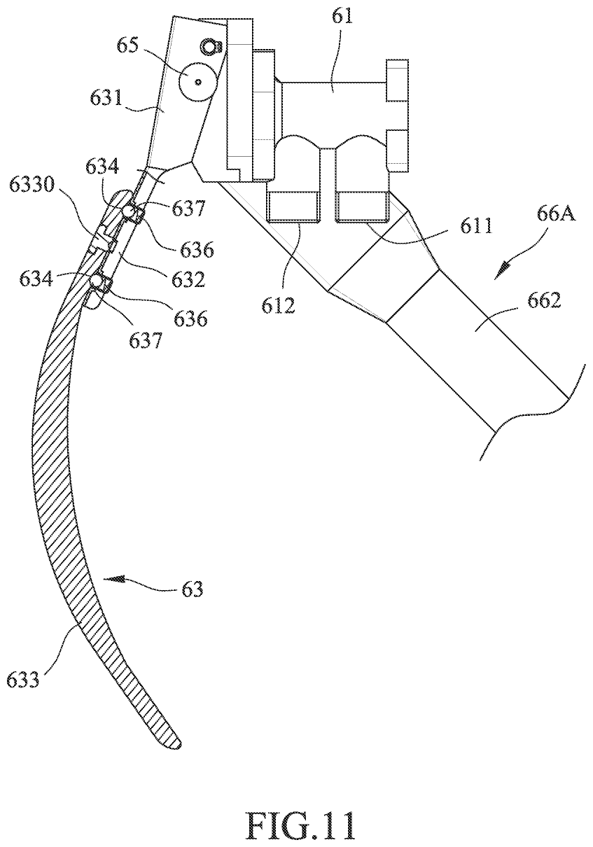

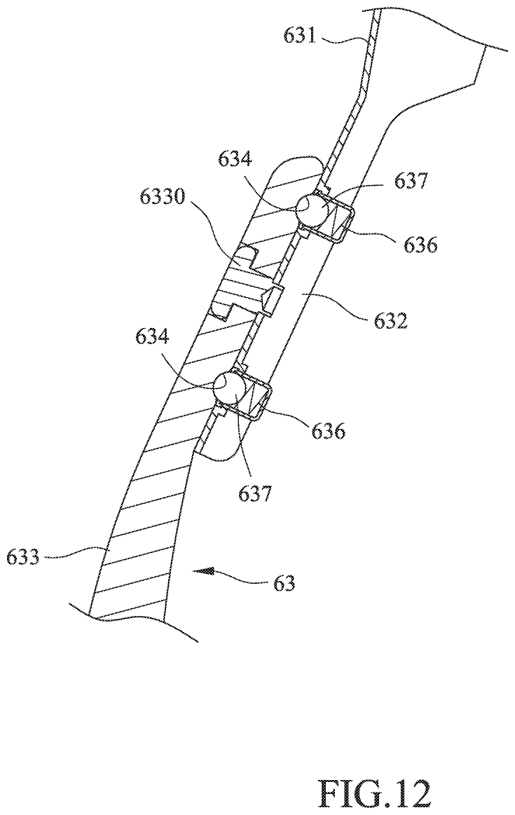

FIGS. 9 to 12 illustrate a water supply control device according to a second embodiment of the disclosure. The difference of the second embodiment from the first embodiment resides in that the second embodiment further includes a mounting rod 66A and a fixing member 68A while the biasing member 67 and the mounting board 66 are dispensed with. The fixing member 68A is disposed below the washbasin 32 and is fixed to a wall 33. The mounting rod 66A is a telescopic rod pivotally connected to the fixing member 68A so as to be pivotable relative to the fixing member 68A. The mounting rod 66A is connected to the valve casing 61 oppositely of the fixing member 68 for holding the valve casing 61 above a floor. The mounting rod 66A has an outer tube 661 and an inner rod 662 axially and movably inserted into the outer tube 661. The outer tube 661 is pivotally connected to the fixing member 68A. The inner rod 662 is connected the valve casing 61. In addition, the actuator 63 further includes an extension lever 633 and a pivot pin 6330 pivotally connecting the extension lever 633 to the trigger portion 632 so that the extension lever 633 is rotatable relative to the trigger portion 632 about the pivot pin 6330 that is transverse to an axis of rotation of the main lever 631. The extension lever 633 first extends outwardly from the trigger portion 632 and then bends to form an arched curve. As shown in FIGS. 10 to 12, the extension lever 633 has an annular recess 635 surrounding the pivot pin 6330 and two positioning holes 634 that are disposed in the annular recess 625 and that are spaced apart angularly with respect to the pivot pin 6330. The trigger portion 632 of the actuator 63 has two spaced apart balls 637 respectively loaded with springs 636. The balls 637 are extendable retractably and respectively into the positioning holes 634 to lock the extension lever 633 against rotational movement relative to the trigger portion 632.

By virtue of the inner rod 662 and the outer tube 661, the valve casing 61 is movable toward or away from the fixing member 68A and is pivtable relative to the fixing member 68A. The water supply control device of the second embodiment is adjustable in position relative to the washbasin 32. When the water supply control device is adjusted and positioned appropriately to the washbasin 32, the extension lever 633 is allowed to be pressed by the user's knee for delivering water through the water dispenser 31.

Because the extension lever 633 is rotatable relative to the trigger portion 632 about the pivot pin 6330, the rotation of the extension lever 633 can reduce injury to the user, especially a child, by reducing the risk of hitting the user. Besides, since the extension lever 633 in use is usually exposed to an environment where people are moving past it, the clothes worn on people are easily caught by the extension lever 633. However, due to the rotatable extension lever 633, it can buffer stresses imposed thereon through a rotating movement so as to avoid damages caused to it. When the balls 67 loaded with the spring 636 respectively protrude into the two positioning holes 634 of the extension lever 633 during rotation of the extension lever 633, the extension lever 633 is locked against rotational movements. When there is an external force to rotate the extension lever 633, the extension lever 633 can be rotated.

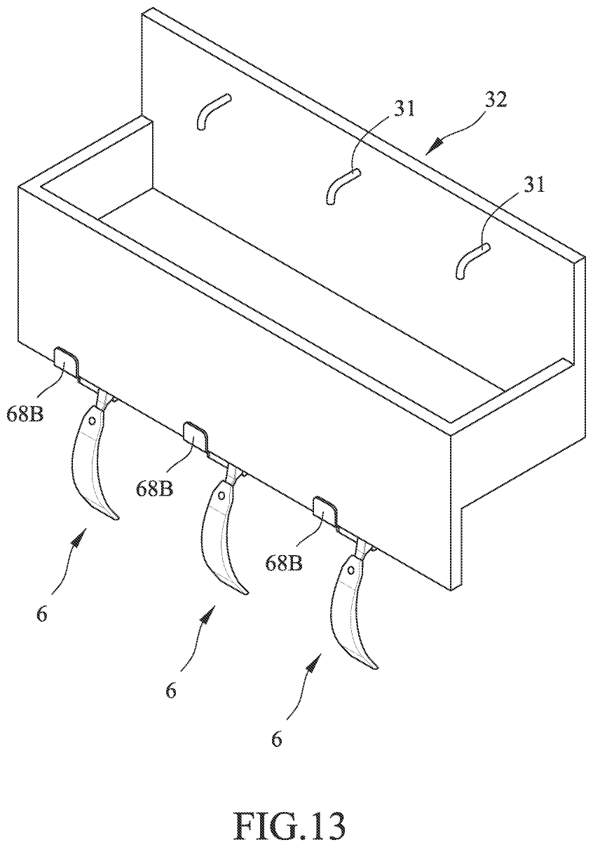

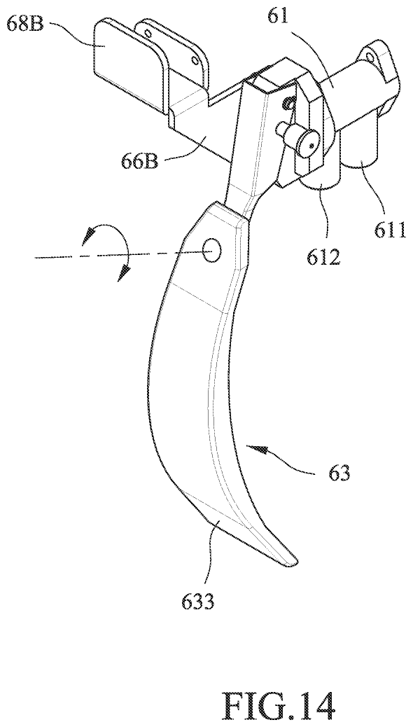

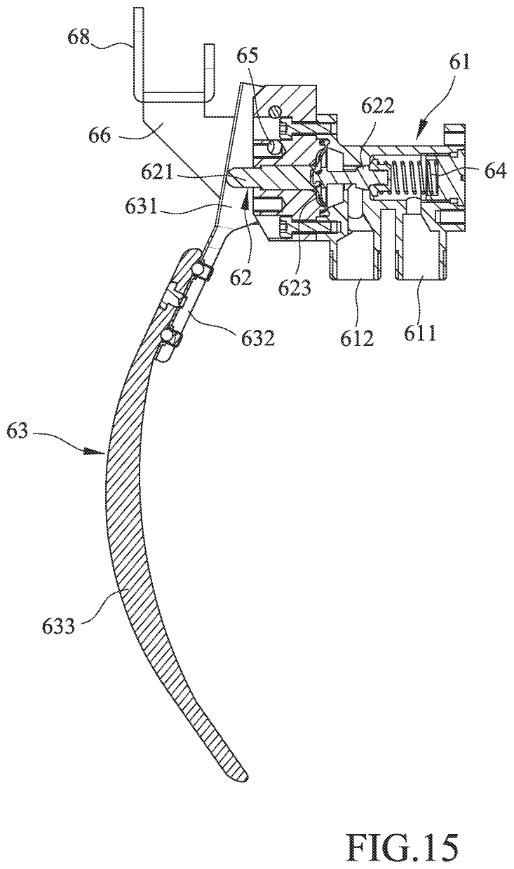

FIGS. 13 to 15 illustrate a water supply control device according to a third embodiment of the disclosure, which has a structure similar to that of the second embodiment. However, the third embodiment includes an extension plate 66B and a bracket 68B instead of the mounting rod 66A and the fixing member 68A of the second embodiment. The extension plate 66B is connected to a side of the valve casing 61. The bracket 68B extends from the extension plate 66B and is secured to the washbasin 32.

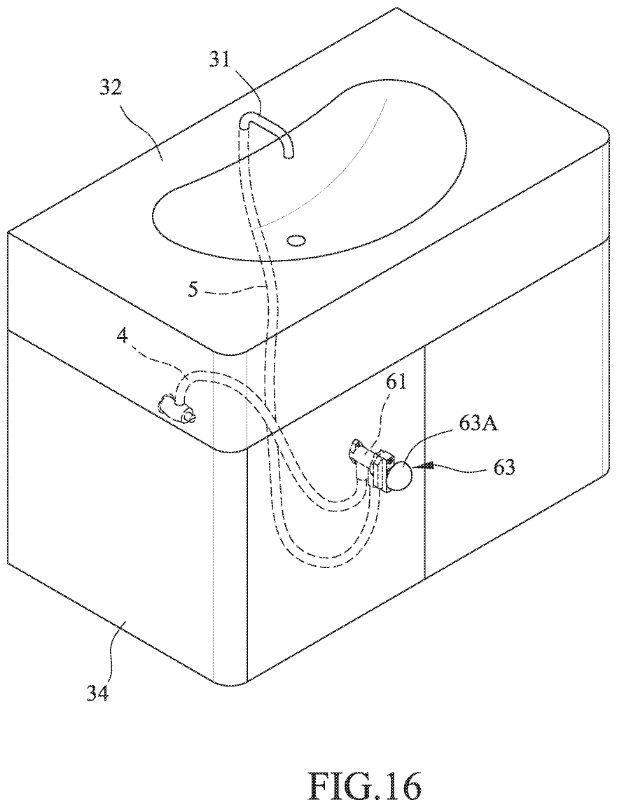

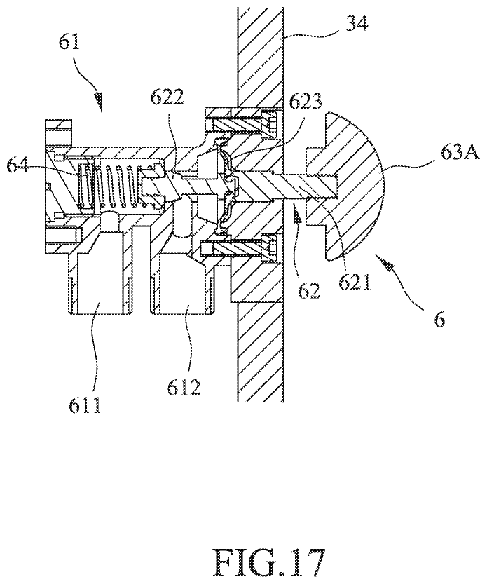

FIGS. 16 and 17 illustrate a water supply control device according to a fourth embodiment of the disclosure, which has a structure similar to that of the first embodiment. However, the difference resides in that the actuator 63 has a press button 63A that is pressable to move the piston 62 to the non-blocking position. The press button 63A of the actuator 63 is screwed to the actuated portion 621 of the piston 62. The actuator 63 of the fourth embodiment has a relatively small size. The valve casing 61 and the actuator 63 can be disposed on a side wall of the basin 32 (not shown) or a cabinet 34 that supports the washbasin 32.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A water supply control device comprising:
a valve unit including
a valve casing having a valve inlet, a valve outlet, and an inside space connected to said valve inlet and outlet, a portion of said inside space near said valve inlet and outlet defining a passage hole for passage of water from said valve inlet to said valve outlet;
a piston movably extending in said inside space, said piston including an actuated portion partially exposed from said inside space, a valve plug portion opposite to said actuated portion and disposed in said passage hole, and a diaphragm member disposed between said actuated portion and said valve plug portion and extending across said inside space, said diaphragm member preventing water from flowing to said actuated portion of said piston from said passage hole;
an actuator to actuate said actuated portion of said piston; and
a resilient member disposed in said inside space and urging said valve plug portion to block said passage hole so that said piston is in a blocking position;
wherein said piston is moved by said actuator to a non-blocking position, where said valve plug portion unblocks said passage hole.

2. The water supply control device as claimed in claim 1, wherein said diaphragm member is formed as a bonnet shape and is made of a rubber material.

3. The water supply control device as claimed in claim 1, wherein
said resilient member abuts with an end of said piston proximate to said valve plug portion,
said valve plug portion of said piston has a conical portion gradually enlarged in a direction toward said resilient member, and
when said piston is moved to the blocking position, said conical portion blocks said passage hole.

4. The water supply control device as claimed in claim 1, further comprising an inlet pipe connected to said valve inlet, an outlet pipe connected to said valve outlet, and a water dispenser connected to said outlet pipe.

5. The water supply control device as claimed in claim 4, wherein said actuator includes a main lever that has a pivoted portion pivotally connected to said valve casing, and a trigger portion opposite to said pivoted portion, said actuated portion of said piston having a protruding end exposed from said inside space and abutting said main lever between said pivoted portion and said trigger portion.

6. The water supply control device as claimed in claim 5, wherein
said valve casing has a lock hole proximate to said pivoted portion of said actuator,
said actuator further includes a locking member disposed on said pivoted portion and extendable into said lock hole, and
when said piston is at the non-blocking position and when said locking member is moved to extend into said lock hole, said piston is immobilized in the non-blocking position.

7. The water supply control device as claimed in claim 5, further comprising
a mounting board to support said valve casing and configured to be positioned to a floor,
and a biasing member,
wherein said trigger portion of said actuator has a foot step plate, said biasing member being connected between said foot step plate and said mounting board.

8. The water supply control device as claimed in claim 5, wherein said actuator further includes an extension lever and a pivot pin pivotally connecting said extension lever to said trigger portion so that said extension lever is rotatable relative to said trigger portion about said pivot pin that is transverse to an axis of rotation of said main lever.

9. The water supply control device as claimed in claim 8, wherein
said extension lever has two positioning holes that are spaced apart angularly with respect to said pivot pin,
said trigger portion of said actuator has two spaced apart balls respectively loaded with springs, and
said balls are extendable retractably and respectively into said positioning holes to lock said extension lever against rotational movement relative to said trigger portion.

10. The water supply control device as claimed in claim 4, wherein said actuator has a press button that is pressable to move said piston to the non-blocking position.

11. The water supply control device as claimed in claim 10, wherein said press button of said actuator is screwed to said actuated portion of said piston.

12. The water supply control device as claimed in claim 4, further comprising a mounting rod connected to said valve casing for holding said valve casing above a floor.

13. The water supply control device as claimed in claim 12, wherein said mounting rod is a telescopic rod that has an outer tube and an inner rod axially and movably inserted into said outer tube.

14. The water supply control device as claimed in claim 13, further comprising a fixing member configured to be fixed to a wall, said mounting rod being pivotally connected to said fixing member so as to be pivotable relative to said fixing member, said valve casing being connected to said mounting rod oppositely of said fixing member.

15. The water supply control device as claimed in claim 1, wherein said valve casing has a first casing part and a second casing part secured to each other, said diaphragm member having a peripheral edge portion being clamped between said first and second casing parts.

16. The water supply control device as claimed in 1, wherein said diaphragm member has a peripheral edge portion fixed to said valve casing, and an intermediate part surrounded by said peripheral edge portion, said piston being divided into first and second piston sections, said first piston section having said actuated portion, said second piston section having said valve plug portion, said intermediate part of said diaphragm member being clamped between said first and second piston sections.

17. The water supply control device as claimed in claim 16, wherein said first piston section has an engagement groove, said second piston section has an engagement protrusion, said intermediate part of said diaphragm member being clamped between said engagement groove and said engagement protrusion.

18. The water supply control device as claimed in claim 17, wherein
said engagement protrusion has a nipple-shaped protrusion formed with a constricted neck, and
a middle of said intermediate part of said diaphragm member has a shape complementary to said nipple-shaped protrusion.

19. The water supply control device as claimed in claim 1, wherein said inside space of said valve casing further defines a piston slide hole receiving said actuated portion of said piston, and a working chamber connected between said piston slide hole and said passage hole, said diaphragm member extending across said working chamber and being movable between a junction of said piston slide hole and said working chamber and a junction of said passage hole and said working chamber.
